(19) United States
(12) Patent Application Publication
(10) Pub. No.: US 2010/0212810 A1
(43) Pub. Date: Aug. 26, 2010

(54) SLEEVE DEVICE, TIRE BUILDING APPARATUS, AND METHOD

(76) Inventor: Michael S. James, Streetsboro, OH (US)

Correspondence Address: BRIDGESTONE AMERICAS, INC., 1200 FIRESTONE PARKWAY, AKRON, OH, 44317, US

(21) Appl. No.: 12/391,757

(22) Filed: Feb. 24, 2009

(51) Int. Cl. B29D 30/08; B29D 30/24

(52) U.S. Cl. 156/110.1; 156/394.1; 156/414

(57) ABSTRACT

Apparatuses and methods are provided for assisting in the installation of a tubular film onto a drum for use in the manufacture of tires. In one embodiment, a sleeve is provided having a body including a first tapered portion with an end surface, a central portion, and a plurality of openings through the body. In another embodiment, a tire building apparatus is provided including a sleeve device and a drum in contact with the sleeve device. A method of making tires is provided including forcing fluid through openings of a sleeve device, placing a tubular film about the sleeve device, and transporting the tubular film onto a drum.

### FIELD OF THE INVENTION

The present invention relates to a sleeve device, a tire building apparatus, and a method of using the sleeve device and the tire building apparatus in the manufacture of tires. More specifically, the present invention relates to a sleeve device and a tire building apparatus for use in handling materials of a tire carcass and a method for making tires using the sleeve device and the tire building apparatus.

### BACKGROUND OF THE INVENTION

The use of cylindrical drums for the formation of tire carcasses is well known. In many known methods a tire drum includes a cylindrical surface that accommodates layers of materials that are used to build a tire carcass. Known methods of making tires include wrapping a flat sheet layer of carcass material, for example an inner liner material, around a drum used to build tires such that the ends of the carcass material overlap, creating an overlap splice. In another method, a sheet of carcass material is wrapped around a drum so that the ends of the carcass material meet without overlapping, creating a butt splice. The tack of the carcass material allows the ends to be held together while additional sheet layers of material are applied to the drum and around the first layer of carcass material. The method includes adding additional layers of carcass material that overlap at different locations around the drum until the drum holds several layers of material to produce a tire carcass. Other components of the tire such as belts and tread are applied and these materials and components are subsequently vulcanized to cross-link and bond the sheet layers of material to produce the finished tire.

One problem associated with these methods of building tires is the creation of non-uniformities in the tire at splice locations. The non-uniformities can originate from the extra thickness created at an overlap splice point, or the reduction of strength at the site of a butt splice. It would be desirable to produce a tire that does not include splices in the carcass, thereby making the tire more uniform around its circumference. However, the rapid installation of a tubular section of carcass material onto a tire building drum has proven quite difficult.

### SUMMARY

In one embodiment of the present invention, a sleeve device for use in the manufacture of tires is provided, the sleeve device comprising a body, at least a portion of which is a substantially circular cross-section, and the body includes a first tapered portion, a central portion, a plurality of openings through the body, and wherein the first tapered portion comprises an end surface.

In another embodiment of the present invention, a tire building apparatus for use in the manufacture of tires is provided. The tire building apparatus comprising: a sleeve device having a body comprising a tapered portion and a plurality of openings, and a drum in contact with the sleeve device.

In yet another embodiment of the present invention, a method of making tires is provided, the method comprising: forcing fluid through openings of a sleeve device; placing a tubular film about the sleeve device; and transporting the tubular film onto a drum in contact with the sleeve device.

### DESCRIPTION OF THE DRAWINGS

The various embodiments of the present invention can be understood by the following drawings and figures. The components are not necessarily to scale.

FIG. 1 is a perspective view illustration of a sleeve device for the manufacture of tires, according to an embodiment of the present invention;

FIG. 2 is a perspective view illustration of a sleeve device for the manufacture of tires, according to another embodiment of the present invention; and

FIG. 3 is a cut away side view of a tire building apparatus that shows the internal components and includes a sleeve device and a drum, according to an embodiment of the present invention.

### DETAILED DESCRIPTION

For convenience, various embodiments of a sleeve device and a tire building apparatus are disclosed. In addition, various methods for the use of the sleeve device and tire building apparatus are disclosed, for example, in the placement of tubular film material in the manufacture of tires. Tubular film material is seamless along its circumference and can be used to replace one or more flat sheet layers used to build a tire carcass. It should be noted, however, that the various embodiments described herein can be also applicable to the installation of tubular films for applications other than those related to the manufacture of tires.

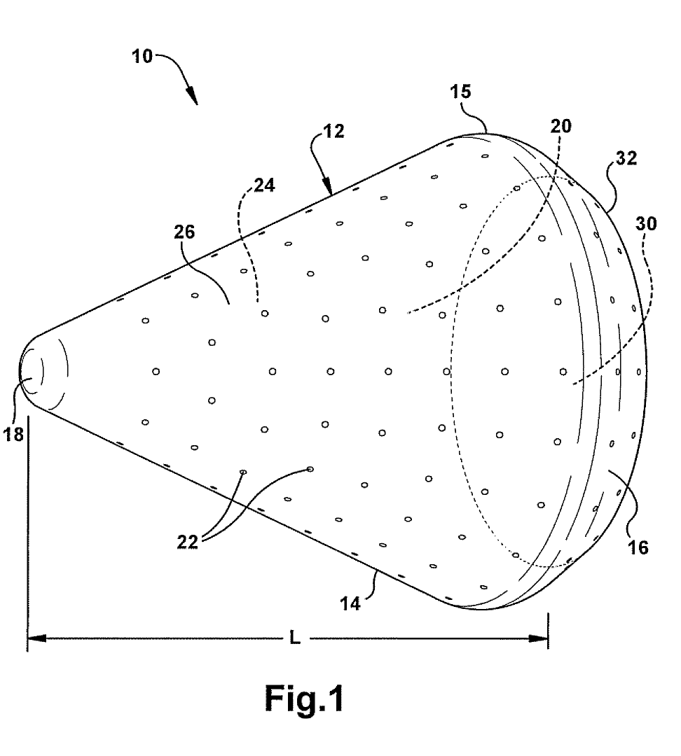

FIG. 1 shows a sleeve device 10 having a body 12 and at least a portion of the body is substantially circular in cross-section. The body 12 includes a first tapered portion 14, a second tapered portion 16, and a central portion 15 disposed between the tapered portions 14, 16. At least one of the tapered portions 14, 16, comprises an end surface, for example end surface 18 of first tapered portion 14. The tapered portions 14, 16 are tapered such that the vertical cross-sectional area of body 12 is decreased relative to the cross-sectional area of the central portion 15 of the body. The body 12 defines a hollow interior portion 20 and a plurality of openings 22.

The tapered portion 14 and the plurality of openings 22 facilitate placement of a tubular film material (not shown) about the perimeter of the sleeve device 10. Fluid, for example, a gas such as air, can flow through the plurality of openings 22 from hollow interior portion 20 of the body 12 and is directed toward the inner surfaces of the tubular film. The openings 22 extend through the thickness of the body 12 from the inner surface 24 to the outer surface 26 of the body 12. The fluid maintains the tubular film in an open position or at least a partially inflated shape as it is moved across the first tapered portion 14 toward the central portion 15 of the sleeve device 10 and beyond. The inner circumference of the tubular film, for example an inner diameter, is greater than the diameter of the sleeve device 10 for example, the diameter of central portion 15.

In another embodiment at least one of the tapered portions of sleeve device 10, for example second tapered portion 16, terminates at an opening 30 that provides an access for fluid to enter the sleeve device. In an example embodiment shown with reference to FIG. 1, the first tapered portion 14 terminates at end surface 18 and the second tapered portion 16 includes opening 30 defined by edge 32 of body 12. The edge 32 and opening 30 can have a variety of shapes, including but not limited to, a substantially circular cross-section, as shown by circular edge 32.

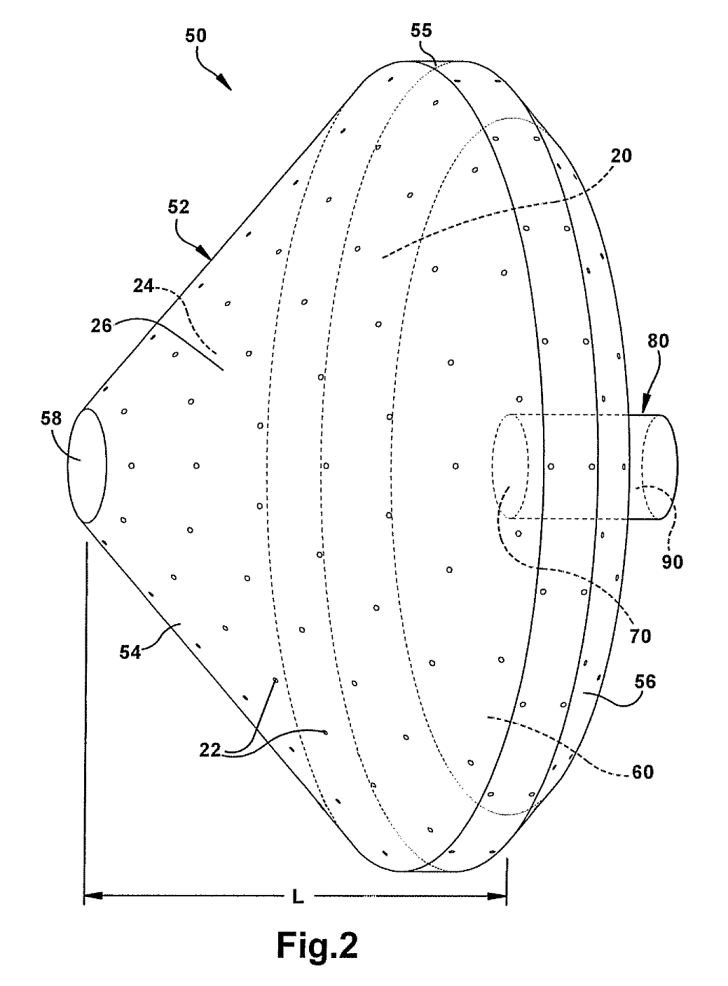

FIG. 2 shows sleeve device 50 in accordance with various embodiments of the present invention. As in FIG. 1, the body 52 includes a first tapered portion 54, a second tapered portion 56 and a central portion 55. At least one of the tapered portions 54, 56, comprises an end surface, for example end surface 58 of first tapered portion 54. A plurality of openings 22 extend through the body 52 from inner surface 24 to outer surface 26.

Sleeve device 50 optionally includes an end wall 60 that extends from the second tapered portion 56 of body 52. The end wall 60 may be any one of various shapes, for example, a planar, concave, or convex wall. Selection of the configuration or shape of end wall 60 may depend upon the method of manufacturing the sleeve device 50 or the manner in which the sleeve device 50 physically contacts other equipment, such as, for example a drum used to build tires as described below. End wall 60 optionally includes a port 70 that allows for the transfer of a fluid into the interior portion 20 of sleeve device 50. In another embodiment, sleeve device 50 can optionally include a connector, for example connector 80. The connector 80 extends from the port 70 to connect the sleeve device 50 to equipment, as will be further described. The connector 80 includes a passage 90 along its length to permit the transmittal of a fluid through the connector 80 and into the interior portion 20 of sleeve device 50.

As shown in FIGS. 1 and 2, the central portions 15 and 55 of body 12 and body 52, respectively, can have a variety of shapes. For example, as shown in FIG. 1, the outer surface 26 of body 12 is substantially arcuate along central portion 15 between the first tapered portion 14 and the second tapered portion 16. As another example, FIG. 2 shows that central portion 55 is substantially cylindrical and outer surface 26 of body 52 along central portion 55 is substantially planar. The central portions provide a smooth surface and can prevent the snagging of a tubular film as it traverses the body 12 and 52. Several surface shapes, or profiles, are possible for the central portions of sleeve device 10 and 50.

Likewise, end surfaces 18 and 58 of sleeve devices 10 and 50 may also be contoured in one of many possible shapes. In one embodiment, the first tapered portion 14 (FIG. 1) has a conical shape that defines the end surface 18, and first tapered portion 54 (FIG. 2) has a planar shape that defines the end surface 58.

Alternatively, in any of the embodiments described above and shown in FIGS. 1 and 2, the sleeve device 10, 50, includes a body 12, 52 with a longitudinal length, L. The vertical cross-section of body 12, 52 can vary along the longitudinal length, L, and in yet another embodiment, the cross-section of sleeve device 10, 50, has a substantially circular cross-section along the entire longitudinal length L.

In the various embodiments described above with respect to sleeve device 10, 50, described above (FIGS. 1 and 2), the plurality of openings 22 are present in at least one of the first tapered portion 14, 54, the central portion 15, 55, the second tapered portion 16, 56, and the end surface 18, 58. Thus, in another embodiment, the openings 22 extend through the first tapered portion 14, 54, the central portion 15, 55, and the second tapered portion 16, 56. The openings 22 may be present in a variety of sizes and shapes, and may be arranged in various patterns and proximities to one another, for example, to achieve various hole densities or ratios. For example, the hole density or hole ratio is the ratio of open surface area to the surface area of the body 12 without openings, and can be adjusted to achieve desired fluid pressure.

One of ordinary skill in the art will recognize that the sleeve device 10, 50, described above (FIGS. 1 and 2), may be constructed of one or more of a variety of materials. For example, the sleeve device 10, 50, may be constructed of a metal, a polymer, a composite material, or any combination thereof. Other suitable materials capable of performing the desired functions of sleeve device 10, 50, as described below, will be readily apparent to the skilled artisan.

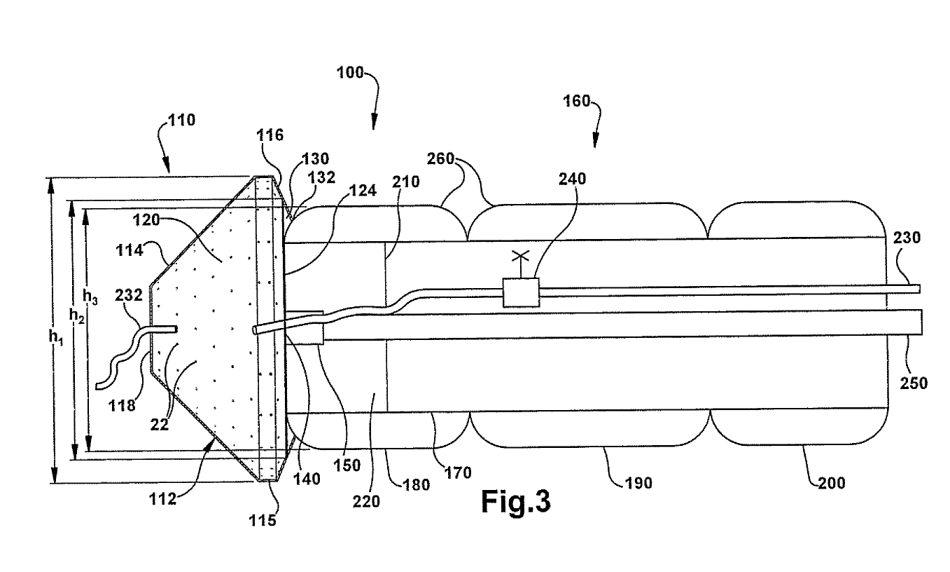

FIG. 3 shows a tire building apparatus 100 for use in the manufacture of tires, according to another embodiment of the present invention. The tire building apparatus 100 includes sleeve device 110 and drum 160 proximate the sleeve device 110. Sleeve device 110 includes a body 112 having a tapered portion 114 and a plurality of openings 22.

In one embodiment the sleeve device 110 of tire building apparatus includes central portion 115 and tapered portion 114, which terminates at end surface 118. End surface 118 can be one of many geometric configurations, such as conical or planar as described above for example. Sleeve device 110 is in contact with drum 160 at an end of sleeve device opposite end surface 1 18. Openings 22 are optionally present in the central portion 115 and optionally the tapered portion 114.

In one embodiment sleeve device 110 terminates at an opening 130. Sleeve device 110 optionally includes an end wall 124 that extends from the body 112 proximate drum 160. Several of various configurations of sleeve device 110 are possible, including the various embodiments of sleeve device 10 and 50 described above with respect to FIGS. 1 and 2. Body 112 of sleeve device 110 defines a hollow interior portion 120.

The drum 160 is also hollow and has an internal wall or surface 170 and optionally includes at least one bladder, for example first bladder 180, a second bladder 190, and a third bladder 200. The bladders 180, 190, 200 can be pressurized and depressurized to change the location of the external surfaces of the bladders and are known to one of skill in the art of tire building.

The maximum outside dimension, h₁, of at least a portion of the sleeve device 110, for example along central portion 115 is approximately equal to or greater than the maximum outer dimension, h₃, of the drum 160. Fluid, such as air, passes from the interior cavity 120 of the sleeve device and through the plurality of openings 22 to force a tubular film in an open position or at least a partially inflated shape as it is moved across the first tapered portion 114 and to the drum 160. In another embodiment, at least a portion of second tapered portion 116 has an outer dimension h₂ that extends beyond the outer dimension h₃ of drum 160. In this design, a plurality of openings 22 in the second tapered portion 116 of the sleeve device 110 allow movement of fluid or air along the outer surfaces 260 of drum 160 to better facilitate movement of tubular film along the drum.

As described above, tapered portion 114 of sleeve device 110 has end surface 118 and second tapered portion 116 can terminate at an opening defined by edge 132 similar to that shown by edge 32 (FIG. 1). In the example embodiment of FIG. 3, sleeve device 110 has a substantially circular cross-section and is substantially concentric with first bladder 180. The sleeve device 110 is positioned so that edge 132 surrounds at least a small portion of the first bladder 180. Also, central portion 115, and second tapered portion 116 have outer dimensions h₁ and h₂, respectively, which are approximately equal to or greater than the outside diameter, h₃, of the drum 160.

In one embodiment the interior of the drum 160 is substantially hollow, with both ends of the drum normally being open to the atmosphere. In such case, the sleeve device 110 of tire building apparatus 100 includes a wall, for example end wall 124. In another embodiment the tire building apparatus 100 includes a barrier 210 disposed within the drum 160, or upon one or both ends of the drum. The barrier 210 prevents the flow of fluid out of the end of the drum not in contact with the sleeve device 110. Once installed, the barrier 210 creates an internal cavity 220 in the tire building apparatus 100 defined by the inside surface 170 of the tire building drum 160, the barrier 210, and the sleeve device 110. Thus, at least a portion of the tire building apparatus 100 includes a defined volume that can be pressurized.

In another embodiment, the tire building apparatus 100 includes a fluid supply conduit 230 in contact with the sleeve device 110 and a fluid source (not shown) in such a manner as to permit the transfer of fluid between the sleeve device and the fluid source. In an alternative embodiment, the tire building apparatus 100 further includes a fluid supply valve 240 operatively connected to fluid supply conduit 230. In another embodiment, the fluid supply conduit 230 is operatively connected to both a fluid source and the internal pressure cavity 220. Optionally, fluid supply conduit 230 is in contact with at least one of first bladder 180, second bladder 190, and third bladder 200, so as to permit the transfer of fluid to one or more of the first, second, and third bladders. The fluid supply valve 240 may control the flow of fluid to at least one of the first bladder 180, the second bladder 190, the third bladder 200, and the internal pressure cavity 220.

In one embodiment, the tire making apparatus 100 includes a sleeve device 110 as described above, a drum 160, and a fluid delivery device 232 connected to the sleeve device, and a fluid source (not shown). A fluid delivery device 232 may be operatively connected to the fluid source. A fluid delivery device 232 may be in contact with the sleeve device 110 in such a manner as to permit the transfer of a fluid from the fluid delivery device to the sleeve device. The fluid delivery device 232 may contact the sleeve device 110 in a variety of locations, for example, internally or externally at one of many locations along body 112. In one embodiment, a fluid delivery device 232 may be in contact with the sleeve device 110 at end surface 118.

The tire building apparatus 100 as shown in FIG. 3 can be used in the manufacture of tires. A drum 160 is in contact with a sleeve device 10, 50, 110 as described above and in FIGS. 1, 2, and 3. A fluid source is provided that is capable of providing a fluid with a pressure of up to about 700 kPa, at a volume flow rate of up to about 0.15 m³/s. A fluid is directed into the interior 120 of the sleeve device 110, thereby pressurizing the interior. The fluid is permitted to flow from the interior 120 of the sleeve device 110 through the openings 22 in sleeve body 112. A seamless tubular film is placed around the perimeter of sleeve device 110 and transported onto the drum 160. Once the film is on the drum, the interior 120 of the sleeve device 110 can be depressurized if desired.

The area, shape, and number of the openings 22 will vary according to the pressure of the fluid supplied, volume flow rate of the fluid supplied, and the desired force to be applied to the particular material that will be placed about the sleeve device. The force applied will depend upon the nature of the tubular material to traverse the sleeve device, for example, the size, weight, and permeability of the material. The area of each opening 22 can be up to about 150 mm². In another embodiment, the area of each opening can range from about 1 mm² to about 100 mm². In yet another embodiment, the area of each opening can range from about 5 mm² to about 50 mm². The combined total area of the openings 22 may be up to about 1300 cm². In another embodiment, the combined total area of the openings 22 may range between 50 cm² and 1000 cm².

In one embodiment, a method for making tires includes placing a sleeve device 110 having an opening 130 defined by an edge 132 is positioned so that edge 132 encompasses and overlaps a small portion of the first bladder 180. In another embodiment, apparatus further includes a fluid supply valve 240 as described above with respect to FIG. 3, which selectively allows fluid to enter the first bladder 180, which expands against the edge 132 of sleeve device 110 to create a fluid-tight seal. The fluid enters the first bladder 180 at a pressure up to about 700 kPa. In another embodiment, the fluid entering the bladder ranges from about 5 kPa to about 400 kPa. In yet another embodiment, the fluid entering the bladder ranges from about 5 kPa to 100 kPa. Since sleeve 110 has opening 130, a barrier 210 may be installed on the interior of the drum 160 as described above with respect to FIG. 3 to create a contained volume that can be pressurized.

In an alternative embodiment, the drum 160 includes an axle 250 inside and substantially concentric with the drum. The axle 250 extends substantially the entire length of the drum 160. The sleeve device 110 includes an end wall 124, a port 140, and a connector 150. The connector 150 is removably connected to the axle 250. The drum 160 includes a fluid supply valve 240 that is operatively connected to a fluid source and connector 150 by the fluid supply conduit 230. In yet another embodiment, the fluid source is connected to a fluid delivery device 232. The fluid delivery device 232 directs fluid to the interior portion 120 of the sleeve device 110. The fluid delivery device 232 may be connected to the sleeve device 110 in a variety of positions, for example, end surface 118, body 112, end wall 124, and port 140. The barrier 210 is not necessary in these alternative embodiments.

In another embodiment, any of the methods described above can further include the step of placing a tubular film around the perimeter of the sleeve device 110 at the end surface 118. Fluid flows at a constant flow rate from the plurality of openings 22 to contact the inner surface of the tubular film. The fluid acts to keep the tubular film in its inflated shape. The inner dimension of the tubular film is greater than the maximum dimension of the sleeve device 110. The tubular film is transported the longitudinal length of the sleeve device 110 and onto the drum 160. As the sleeve device advances past the maximum dimension portion of the sleeve device 110, the flow of fluid from the plurality of openings 22 is bounded on one side by the inner surface of the tubular film and bounded on the other side by the outer surface 260 of the drum 160. The flow of the fluid creates a cushion of fluid to keep the tubular film in its inflated shape and reduce the friction between the inner surface of the tubular film and the outer surface 260 of the drum 160. In one embodiment, this cushion of fluid between the film and the drum 160 is directed from the second tapered end portion 116 of the sleeve device 110. Once the tubular film has been transported to its desired position on the tire building drum 160, the flow of fluid is discontinued, allowing the tubular film to relax and lie about the outer surface 260 of the drum 160.

The fluid supply valve 240 selectively directs a fluid through the fluid supply conduit 230 to the internal pressure cavity 220. The fluid enters the internal pressure cavity 220 at a pressure up to about 700 kPa. In another embodiment, the fluid entering the internal pressure cavity 220 ranges from about 30 kPa to about 400 kPa. In yet another embodiment, the fluid entering the internal pressure cavity 220 ranges from about 50 kPa to about 250 kPa. The fluid flows into the internal pressure cavity 220 at a volume flow rate up to about 0.15 m³/s. In another embodiment, the fluid flows into the internal pressure cavity 220 at rate ranging from about 0.01 m³/s to about 0.08 m³/s. In yet another embodiment, the fluid flows into the internal pressure cavity 220 at rate ranging from about 0.02 m³/s to about 0.06 m³/s. The fluid in the internal pressure cavity 220 flows into the inner cavity 120 of the sleeve device 110 and out the plurality of openings 22.

While embodiments of the invention have been described, it would be understood by those skilled in the art that various changes may be made and equivalence may be substituted for the sleeve device, the tire building apparatus, and method of making tires without departing from the scope of the invention. For example, although example embodiments discussed above pertain to tires, it should be understood that several other applications may find use of the sleeve device and the tire building apparatus. In addition, several different sleeve device designs may be used to facilitate placement of tubular material about the sleeve. Therefore, many modifications may be made to adapt the sleeve device and tire building apparatus to the teachings of the invention without departing from the essential scope thereof. Therefore, it is intended that the invention not be limited to particular embodiments, but that the invention will include all embodiments falling within the scope of the pending claims.

What is claimed is:

1. A sleeve device for use in the manufacture of tires comprising:
a body, at least a portion of which is a substantially circular cross-section, the body comprising:
a first tapered portion;
a central portion;
a plurality of openings through the body; and
wherein the first tapered portion comprises an end surface.

2. The sleeve device of claim 1, further comprising a second tapered portion.

3. The sleeve device of claim 1, wherein the first tapered portion and the end surface of the body define a conical shape.

4. The sleeve device of claim 1, wherein the end surface is substantially planar.

5. The sleeve device of claim 2, wherein the first tapered portion comprises an end and the sleeve device further comprises an end wall that extends from the second tapered portion of the body.

6. The sleeve device of claim 5, wherein the end wall comprises a port.

7. The sleeve device of claim 6, further comprising a connector in contact with the end wall that extends from the port.

8. The sleeve device of claim 2, wherein a portion of the body is substantially cylindrical in shape between the first tapered portion and the second tapered portion.

9. The sleeve device of claim 1, wherein a longitudinal cross-section of the central portion is arcuate.

10. The sleeve device of claim 2, wherein the first tapered portion is substantially void of openings and the second tapered portion has an opening.

11. The sleeve device of claim 10, wherein the opening is substantially circular in cross-section.

12. The sleeve device of claim 1, wherein the body has a longitudinal length and a substantially circular cross-section along the longitudinal length.

13. A tire building apparatus for use in the manufacture of tires, comprising:
a sleeve device comprising a body comprising a tapered portion and a plurality of openings; and
a drum in contact with the sleeve device.

14. The tire building apparatus of claim 13, wherein the tapered portion comprises an end surface, and the drum is in contact with the sleeve device opposite the end surface.

15. The tire building apparatus of claim 13, wherein a portion of the sleeve device overlaps at least a portion of the drum.

16. The tire building apparatus of claim 13, wherein the drum is cylindrical and at least a portion of the sleeve device comprises an outside dimension approximately equal to or greater than the outside dimension of at least a portion of the drum.

17. The tire building apparatus of claim 13, wherein:
the drum is cylindrical; and
the sleeve device comprises a second tapered portion and at least a portion of the second tapered portion comprises an outside dimension approximately equal to or greater than the outside dimension of at least a portion of the drum.

18. The tire building apparatus of claim 14, wherein the sleeve device further comprises an end wall opposite the end surface of the sleeve device and proximate the drum.

19. The tire building apparatus of claim 13, wherein the vertical cross-section of the sleeve device and the drum are substantially concentric.

20. The tire building apparatus of claim 13, further comprising a barrier disposed inside drum.

21. The tire building apparatus of claim 20, further comprising an internal pressure cavity defined by the drum, the barrier, and the sleeve device.

22. The tire building apparatus of claim 13, further comprising a fluid supply conduit disposed within the drum and the sleeve device.

23. The tire building apparatus of claim 22, further comprising a fluid supply valve connected to the fluid supply conduit.

24. The tire building apparatus of claim 21, further comprising a fluid supply conduit connected to the internal pressure cavity.

25. The tire building apparatus of claim 18, further comprising a fluid supply conduit connected to the end wall.

26. The tire building apparatus of claim 13, further comprising a fluid delivery device connected to the sleeve device.

27. A method of making tires, comprising the steps of:
forcing fluid through openings of a sleeve device;
placing a tubular film about the sleeve device; and
transporting the tubular film onto a drum in contact with the sleeve device.

28. The method of claim 27, wherein the forcing fluid through openings comprises forcing a fluid at a maximum pressure of about 700 kPa.

29. The method of claim 27, wherein the forcing fluid through openings comprises forcing a fluid at a volume flow rate not exceeding 0.15 m³/s.

30. The method of claim 27, wherein an outer dimension h₁ of the sleeve device is greater than an outer dimension h₃ of the drum.

31. The method of claim 27, further comprising directing fluid from the sleeve device along an outer surface of the drum.

32. The method of claim 31, wherein the directing fluid from the sleeve device comprises directing fluid from a second tapered portion of the sleeve device.

33. The method of claim 27, wherein the sleeve device is in contact with the drum such that a portion of the sleeve device overlaps a portion of the drum; and
further comprising forcing a fluid into a first bladder at a maximum pressure of about 700 kPa.
